(19) United States
(12) Patent Application Publication
(10) Pub. No.: US 2014/0188335 A1
(43) Pub. Date: Jul. 3, 2014

(54) ADAPTIVE EXPERIENCE FRAMEWORK FOR AN AMBIENT INTELLIGENT ENVIRONMENT

(71) Applicant: CLOUDCAR, INC., Los Altos, CA (US)

(72) Inventors: Ajay Madhok, Los Altos, CA (US); Evan Malahy, Santa Clara, CA (US); Ron Morris, Seattle, WA (US)

(73) Assignee: CLOUDCAR, INC., Los Altos, CA (US)

(21) Appl. No.: 13/730,922

(22) Filed: Dec. 29, 2012

(51) Int. Cl. G06F 9/50

(52) U.S. Cl. CPC G06F 9/5005
USPC 701/36; 718/104

(57) ABSTRACT

A system and method for providing an adaptive experience framework for an ambient intelligent environment are disclosed. A particular embodiment includes: detecting as context change in an environment causing a transition to a current temporal context; assigning, by use of is data processor, as task set from a set of contextual tasks, the task set assignment being based on the current temporal context; activating the task set; and dispatching a set or interaction resources, corresponding to the contextual tasks in the task set, to present a state of the current temporal context to a user by use of a plurality of interaction devices corresponding to the set of interaction resources.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2010-2012, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to an ambient intelligent environment supported by a cloud-based vehicle information and control system.

### BACKGROUND

An increasing number of vehicles are being equipped with one or more independent computer and electronic processing systems. Certain of the processing systems are provided for vehicle operation or efficiency. For example, many vehicles are now equipped with computer systems for controlling engine parameters, brake systems, tire pressure and other vehicle operating characteristics. A diagnostic system may also be provided that collects and stores information regarding the performance of the vehicle's engine, transmission, fuel system and other components. The diagnostic system can typically be connected to an external computer to download or monitor the diagnostic information to aid a mechanic during servicing of the vehicle.

Additionally, other processing systems may be provided for vehicle driver or passenger comfort and/or convenience. For example, vehicles commonly include navigation and global positioning systems and services, which provide travel direction and emergency roadside assistance. Vehicles are also provided with multimedia entertainment systems that include sound systems, e.g., satellite radio, broadcast radio, compact disk and MP3 players and video players. Still further, vehicles may include cabin climate control, electronic seat and mirror repositioning and other operator comfort features.

However, each of the above processing systems is independent, non-integrated and incompatible. That is, such processing systems provide their own sensors, input and output devices, power supply connections and processing logic. Moreover, such processing systems may include sophisticated and expensive processing components, such as application specific integrated circuit (ASIC) chips or other proprietary hardware and/or software logic that are incompatible with other processing systems in the vehicle or the surrounding environment.

Additionally, consumers use their smart phones for many things (there is an app for that). They want to stay connected and bring their digital worlds along when they are driving a vehicle. They expect consistent experiences as they drive. But, smartphones and vehicles are two different worlds. While the smartphone enables their voice and data to roam with them, their connected life experiences and application (app)/service relationships do not travel with them in a vehicle.

Consider a vehicle as an environment that has ambient intelligence by virtue of its sensory intelligence, IVI (in-vehicle infotainment) systems, and other in-vehicle computing or communication devices. The temporal context of this ambient intelligent environment of the vehicle changes dynamically (e.g., the vehicle's speed, location, what is around the vehicle, weather, etc. changes dynamically) and the driver may want to interact in this ambient intelligent environment with mobile apps and, or cloud based services. However, conventional systems are unable to react and adapt to these dynamical changing environments.

As computing environments become distributed, pervasive and intelligent, multi-modal interfaces need to be designed that leverage the ambient intelligence of the environment, the available computing resources (e.g., apps, services, devices, in-vehicle processing subsystems, an in-vehicle heads-up display (HUD), an extended instrument cluster, a Head-Unit, navigation subsystems, communication subsystems, media subsystems, computing resources on mobile devices carried into a vehicle or mobile devices coupled to an in-vehicle communication subsystem, etc.), and the available interaction resources. Interaction resources are end points (e.g., apps, services, devices, etc.) through which a user can consume (e.g., view, listen or otherwise experience) output produced by another resource. However, is difficult to design a multi-modal experience that adapts to a dynamically changing environment. The changes in the environment may he the availability or unavailability of a resource, such as an app, service or a device, a change in the context of the environment, or temporal relevance. Given the dynamic changes in the ambient intelligent environment, the user experience needs to transition smoothly from one context of use to another context while conforming to the constraints and maintaining consistent usability and relevance.

Today, there is a gap between the actual tasks a user should be able to perform and the user interfaces exposed by the applications and services to support those tasks while conforming to the dynamically changing environments and related constraints. This gap exists because the user interfaces are typically not designed for dynamically changing environments and they cannot be distributed across devices in ambient intelligent environments.

There is a need for design frameworks that can be used to create interactive, multi-modal user experiences for ambient intelligent environments. The diversity of contexts of use such user interfaces need to support require them to work across the heterogeneous interaction resources in the environment and provide dynamic binding with ontologically diverse applications and services that want to be expressed.

Some conventional systems provide middleware frameworks that enable services to interoperate with each other while running on heterogeneous platforms; but, these conventional frameworks do not provide adaptive mapping between the actual tasks a user should be able to perform and the user interfaces exposed by available resources to support those tasks.

There is no framework available today that can adapt and transform the user interface for any arbitrary service at run-time to support a dynamically changing environment. Such a framework will need to support on-the-fly composition of user interface elements, such that the overall experience remains contextually relevant, optimizing the available resources while conforming to any environmental constraints. Further, the framework must ensure that the resulting user interface at any point in time is consistent, complete and continuous; consistent because the user interface must use a limited set of interaction patterns consistently to present the interaction modalities of any task; complete because all interaction tasks that are necessary to achieve a goal must be accessible to the user regardless of which devices may be available in the environment; continuous because the framework must orchestrate and manage all transitions as one set of tasks in a progression to another set of tasks. No such framework exists today that, visualizes and distributes user interfaces dynamically to enable the user to interact with an ambient computing environment by allocating tasks to interaction resources in a manner that the overall experience is consistent, complete, and continuous.

### SUMMARY

A system and method for providing an adaptive experience framework for an ambient intelligent environment are disclosed herein in various example embodiments. An example embodiment provides a user experience framework that can be deployed to deliver consistent experiences that adapt to the changing context of a vehicle and the user's needs and is inclusive of any static and dynamic applications, services, devices, and users. Apart from delivering contextually relevant and usable experiences, the framework of an example embodiment also addresses distracted driving, taking into account the dynamically changing visual, manual and cognitive workload of the driver.

The framework of an example embodiment provides a multi-modal and integrated experience that adapts to a dynamically changing environment. The changes in the environment may be caused by the availability or unavailability of a resource, such as an app, service or a device; or a change in the temporal context of the environment; or a result of a user's interaction with the environment. As used herein, temporal context corresponds to time-dependent, dynamically changing events and signals in an environment. In a vehicle-related embodiment, temporal context can include the speed of the vehicle (and other sensory data from the vehicle, such as fuel level, etc.), location of the vehicle, local traffic at that moment and place, local weather, destination, time of the day, day of the week, etc. Temporal relevance is the act of making sense of these context-changing events and signals to filter out signal from noise and to determine what is relevant in the here and now. The various embodiments described herein use a goal-oriented approach to determine how a driver's goals (e.g., destination toward which the vehicle is headed, media being played/queued, conversations in progress/likely, etc.) might change because of a trigger causing a change in the temporal context The various embodiments described herein detect a change in temporal context to determine (reason and infer) what is temporally relevant. Further, some embodiments infer not only what is relevant right now, but also predict what is likely to be relevant next. Given the dynamic changes in the ambient intelligent environment, the user experience transitions smoothly from one context of use to another context while conforming to the constraints and maintaining consistent usability and relevance.

The framework of an example embodiment also adapts to a dynamically changing environment as mobile devices, and the mobile apps therein, are brought into the environment. Because the presence of new mobile devices and mobile apps brought into the environment represent additional computing platforms and services, the framework of an example embodiment dynamically and seamlessly integrates these mobile devices and mobile apps into the environment and into the user experience. In a vehicle-related environment, an embodiment adapts to the presence of mobile devices and mobile apps as these devices are brought within proximity of a vehicle; and the apps are active and available on the mobile device. The various embodiments integrate these mobile devices/apps into the vehicle environment and with the other vehicle computing subsystems available therein. This integration is non-trivial as there may be multiple mobile apps that a use might want to consume; but, each mobile app may be developed by potentially different developers who use different user interfaces and/or different application programming interfaces (APIs). Without the framework of the various embodiments, the variant interfaces between mobile apps would cause the user interface to change completely when the user switched from one app or one vehicle subsystem to another. This radical switch in the user interface occurs in conventional systems when the user interface of a foreground application completely takes over all of the available interaction resources. This radical switch in the user interface can be confusing to a driver and can increase the driver's workload, which can lead to distracted driving as the driver tries to disambiguate the change in the user interface context from one app to another. In some cases, multiple apps cannot be consumed as such by the driver in a moving car, if the user interface completely changes from one app to the next. For example, the duration and frequency of interactions required by the user interface may make it unusable in the context of a moving car. Further, when the driver is consuming a given application, a notification from another service or application can be shown overlaid on top of the foreground application. However, consuming the notification means switching to the notifying app where the notification can be dealt with/actioned. Context switching of apps, again, increases the driver workload as the switched app is likely to look and feel differently and to have its own interaction paradigm.

The various embodiments described herein eliminate this radical user interface switch when mobile devices/apps are brought into the environment by providing an inclusive framework to consume multiple applications (by way of their intents) in one, integrated user experience. The various embodiments manage context switching, caused by application switching, through the use of an integrated user experience layer where several applications can be plugged in simultaneously. Each application can be expressed in a manner that does not consume all the available interaction resources. Instead, a vertical slice (or other user interface portion or application intent) from each of the simultaneously in use applications can be expressed using a visual language and interaction patterns that make the presentation of each of the simultaneously in-use tasks homogenous, thereby causing the user experience to be consistent across each of the in-use applications.

The embodiments described herein specify the application in terms of its intent(s), that is, the set of tasks that help a user accomplish a certain goal. The application intent could be enabling a user task (or an activity), a service, or delivering, a notification to the user. The application's intent can be specified in application messages. These messages can carry the information required to understand the temporal intent of the application in terms of the object (e.g., the noun or content) of the application, the input/output (I/O) modality of the intent/task at hand (e.g., how to present the object to the user), and the actions (e.g., the verbs associated with the application) that can be associated with the task at hand (the intent). As such, an intent as used herein can refer to a message, event, or request associated with a particular task, application, or service in a particular embodiment. One example embodiment provides a Service Creation interface that enables the developer of the application or service to describe their application's intent so that the application's intent can be handled/processed at run-time. The description of the application's intent can include information, such as the Noun (object) upon which the application will act, the Verbs or the action or actions that can be taken on that Noun, and the Interaction and Launch Directives that specify how to interact with that object and launch a target action or activity the callback application programming interface—API to use). In other words, the Service Creation interface enables a developer to describe their application in terms of intents and related semantics using a controlled vocabulary of Nouns and Verbs that represent well-defined concepts specified in an environment-specific ontology. Further, an application intent description can also carry metadata, such as the application's domain or category, context of use, criticality, time sensitivity, etc. enabling the system to deal appropriately with the temporal intent of the application.

The application's temporal intent description can be received by a particular embodiment as messages. The metadata in the messages can be used to filter, order, and queue the received messages for further processing. The further processing can include transforming the messages appropriately for presentation to the user so that the messages are useful, usable, and desirable. In the context of a vehicle, the processing can also include presenting the messages to the user in a manner that is vehicle-appropriate using a consistent visual language with minimal interaction patterns (keeping only what is required to disambiguate the interaction) that are carefully designed to minimize driver distraction. The processing of ordered application intent description messages includes mapping the particular application intent descriptions to one or more tasks that will accomplish the described application intent. Further, the particular application intent descriptions can be mapped onto abstract I/O objects, At run-time, the abstract I/O objects can he visualized by mapping the abstract I/O objects onto available concrete I/O resources. The various embodiments also perform processing operations to determine where, how, and when to present application information to the user in a particular environment, so that the user can use the application, obtain results, and achieve their goals. Any number of application intent descriptions, from one or more applications, can he requested or published to the various embodiments for concurrent presentation to a user. The various intents received from one or more applications get filtered and ordered based on the metadata, such as criticality and relevance based on the knowledge of the temporal context. The various embodiments compose the application intent descriptions into an integrated user experience employing the environmentally appropriate visual language and interaction patterns. Application intent transitions and orchestration are also handled by the various embodiments. At run-time, the application intent descriptions can he received by the various embodiments using a services gateway as a message or notification receiver.

Further, the experience framework as described herein manages transitions caused by messages. notifications, and changes in the temporal. context. The experience framework of an example embodiment orchestrates the tasks that need to be made available simultaneously for a given temporal context change, manages any state transitions, such that the experience is consistent, complete, and continuous. The experience framework manages these temporal context changes through an equivalent of a composite or multi-modal dialog as opposed to a modal user interface that the foreground application presents in conventional systems.

### BRIEF DESCRIPTION OF THE DRAWINGS

The various embodiments is illustrated by way of example, and not by way of limitation, in the figures of the accompanying drawings in which:

FIG. 1 illustrates an example set of components of the adaptive experience framework of an example embodiment;

FIG. 2 illustrates a task set in an example embodiment of the adaptive experience framework;

FIG. 3 illustrates a task hierarchy in a task set if an example embodiment of the adaptive experience framework;

FIG. 4 illustrates input interaction resources and output interaction resources of an example embodiment of the adaptive experience framework;

FIG. 5 illustrates the components of as task model in an example embodiment of the adaptive experience framework;

FIG. 6 illustrates a notification module of an example embodiment of the adaptive experience framework;

FIG. 7 illustrates a reference model of an example embodiment of the adaptive experience framework;

FIG. 8 illustrates a reference architecture of an example embodiment of the adaptive experience framework;

FIG. 9 illustrates the processing performed by the task model in an example embodiment:

FIGS. 10 and 11 illustrate the processing performed by the adaptive experience framework in an example embodiment;

FIG. 12 illustrates an example of the adaptive experience framework in a vehicle environment in an example embodiment;

FIG. 13 is a processing flow chart illustrating an example embodiment of a system and method for providing an adaptive experience framework for an ambient intelligent environment; and

FIG. 14 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details arc set forth in order to provide a thorough understanding of the various embodiments. It will be evident, however, to one of ordinary skill in the art that the various embodiments may be practiced without these specific details.

As described in various example embodiments, a system and method for providing an adaptive experience framework for an ambient intelligent environment are described herein. In one particular embodiment, a system and method for providing an adaptive experience framework for an ambient intelligent environment is provided in the context of a cloud-based vehicle information and control ecosystem configured and used as a computing environment with access to a wide area network, such as the Internet. However, it will be apparent to those of ordinary skill in the art that the system and method for providing an adaptive experience framework for an ambient intelligent environment as described and claimed herein can be implemented, configured, deployed, and used in a variety of other applications, systems, and ambient intelligent environments. Each of the service modules, models, tasks, resources, or components described below can be implemented as software components executing within an executable environment of the adaptive experience framework. These components can also be implemented in whole or in part as network cloud components, remote service modules, service-oriented architecture components, mobile device applications, in-vehicle applications, hardware components, or the like for processing signals, data, and content for the adaptive experience framework. in one example embodiment, one or more of the service modules of the adaptive experience framework are executed in whole or in part on a computing platform in a vehicle. One or more of the service modules of the adaptive experience framework can also be executed in whole or in part on a computing platform (e.g., a server or peer-to-peer node) in the network cloud 616. In another example embodiment, one or more of the service modules of the adaptive experience framework are executed in whole or in part on a computing platform of a mobile device, such as a mobile telephone (e.g., iPhone™, Android™ phone, etc.) or a mobile app executing therein. Each of these framework components of an example embodiment is described in more detail below in connection with the figures provided herein.

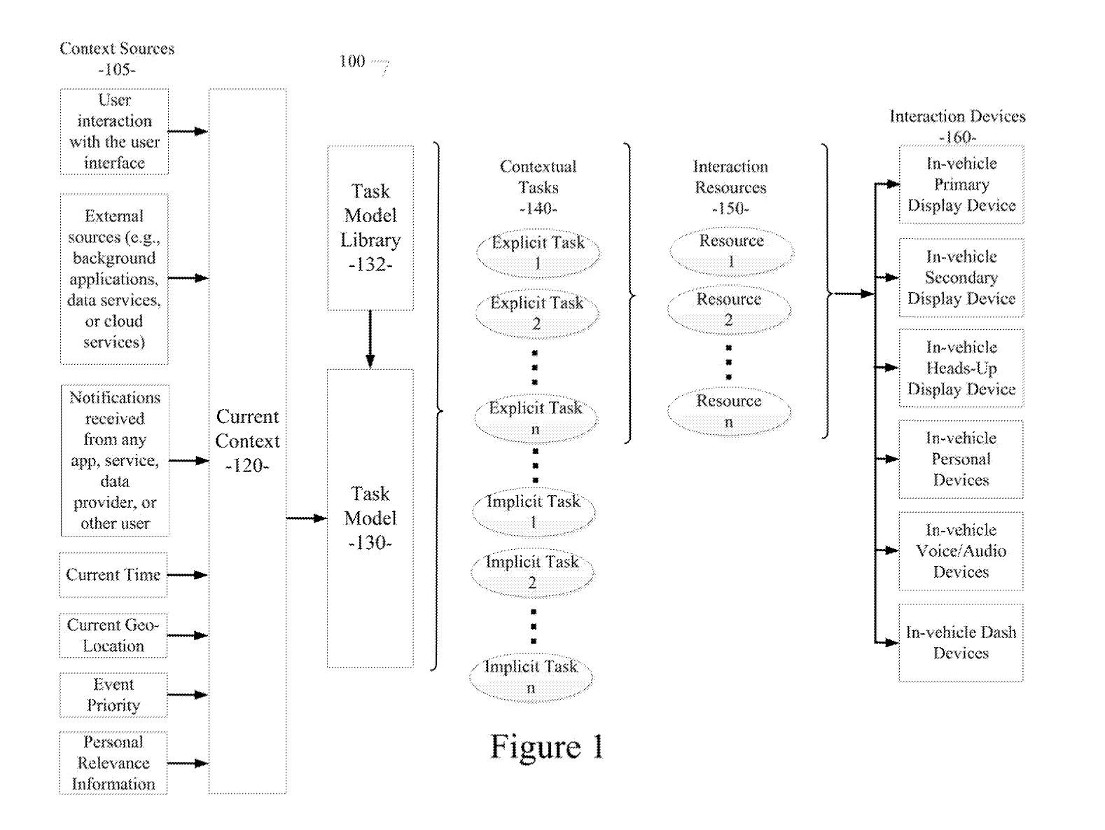

Referring now to FIG. 1, the adaptive experience framework system 100 of an example embodiment is shown in a cloud-based, vehicle information and control ecosystem. In the application with a vehicle ecosystem, the adaptive experience framework system 100 takes into account the driver's needs and goals in a given temporal context 120, mapping these driver needs and goals to a set of contextual tasks 140, and then mapping the contextual tasks to available interaction resources 150 and distributing them across multiple interaction devices 160 in the vehicle ecosystem, orchestrating and managing transitions as the tasks progress. As a result, the driver is presented with one integrated experience. Further, the adaptive experience framework system 100 adapts that integrated experience to change or transition as the context in the vehicle ecosystem or the driver context changes, such that the integrated experience remains consistent, complete, and continuous while addressing distracted driving.

The adaptive experience framework system 100 of an example embodiment provides an integrated experience, because the framework 100 de-couples the native user interfaces of an app or service from its presentation in the context of the vehicle. Instead Of showing whole or entire apps or services with their distinct interfaces, the framework 100 presents vertical slices (or other user interface portions), described herein as intents, from each of the simultaneously in-use apps or services expressed using a visual language and interaction patterns that make presentation of these intents from multiple apps or services homogenous. The framework 100 presents the user interface portions or application/service intents that are contextually relevant to the driver at a particular time. The framework 100 determines which of the available or asserted application/service intents are contextually relevant by determining the goals of the driver in as given context; and by determining the tasks that are associated with the available or asserted application/service intent in the particular context. The tasks determined to he associated with the available or asserted application/service intent in the particular context are grouped into a task set that represents the tasks that need to be made concurrently available to fulfill, those goals. Then, the framework 100 expresses the relevant task set simultaneously in an integrated, experience to maintain interaction and presentation consistency across tasks that may use different apps or methods in multiple apps to fulfill them.

The framework 100 computes the set of tasks 140 that need to be made available in a given context (e.g., such as the tasks that are associated with the available or asserted application/service intent in the particular context) 120 and maps the set of tasks 140 onto interaction resources 150 supporting the temporally relevant, tasks, visualizes the set of tasks 140 using concrete interfaces and deploys the set of tasks 140 on available interaction devices 160 using the interaction resources 150. A mapping and planning process is used by a task model 130 to compute an efficient execution of the required tasks 140 with the interaction resources 150 that are available. Specifically, the task model 130 receives an indication of context changes captured in the current context 120 and performs a set of coordinated steps to transition a current state of the user experience to a new state that is appropriate and relevant to the changed context. In order to detect context changes, the current context 120 is drawn from to variety of context sources 105, including: the user's interaction with the interface; the external (to the user interface) context changes and notifications received from any app, service, data provider, or other user system that wishes to present something to the user/driven the current time and geo-location; the priority or criticality of received events or notifications; and personal relevance information related to the user/driver. The notifications are received as abstract signals, a message that has a well-defined structure that defines the domain, content and actions associated with the notification. The task model 130 cart transform the abstract notification into one or more tasks 140 that need to be performed in a given context 120 corresponding to the notification. The processing of notifications is described in more detail below. Likewise, the task model 130 can identify other tasks 140 that need to be made available or expressed in the new context 120 within a given set of constraints, such as the available interaction devices 160 and their interaction and presentation resources 150.

The task model 130 can interpret any specified application intent in terms of two types of tasks 140 (e.g., explicit tasks and implicit tasks) that can be performed in different contexts of use. Implicit tasks are abstract tasks that do not require any interaction resources 150 and can be fulfilled in the background, such as querying a service or a data/knowledge end-point. Explicit tasks require a concrete interaction resource 150 to be presented and thus explicit tasks have their accompanying interaction modality. An application intent (and its related task set) 140 that can be used, for example, to present a queued media item (e.g., a song selection) is an example of an explicit task. In this example, the queued media needs an interaction device (e.g., the audio sound system) to play the song selection. Another example of an explicit task is an application intent that corresponds to a presentation of a notification to notify the user of a certain event that occurred in an associated application. These explicit tasks either require an interaction device 160 to present output to a user or the explicit task needs the user to take some action, such as make a selection from a given set of choices. Both implicit and explicit tasks might require a specific method or API or a callback function of an application or service to be invoked.

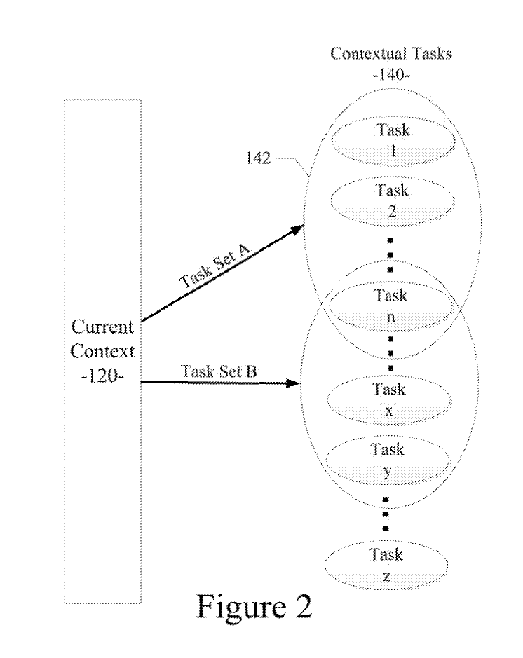

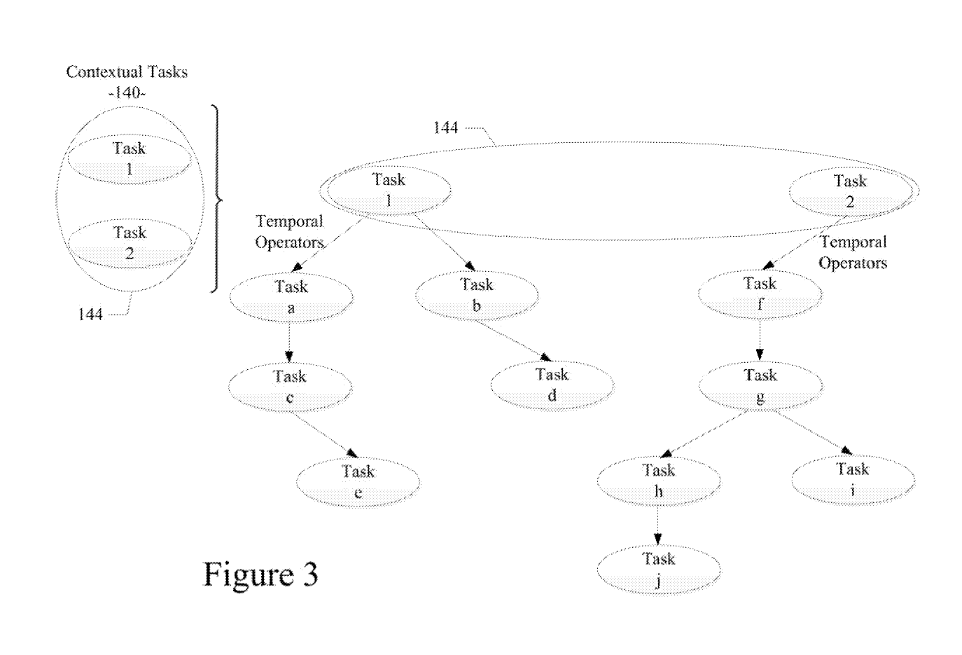

Referring now to FIGS. 2 and 3, given that a context 120 may require multiple application intents (and their related task sets) 140 to be performed concurrently, a grouping of required tasks 140 for the context 120 can be aggregated into a task set, such as task set 142 in FIG. 2 or 144 in FIG. 3, which comprises all the tasks 140 that have the same level in a hierarchy of decomposition of goals, but may have different relevance and information hierarchy. An example of a task hierarchy is shown in FIG. 3. The task hierarchy of the task set defines the set of tasks to be performed to transition to the new context and to meet the goals specified by a user or the system. As shown in FIG. 3, the framework 100 connects the tasks 140 in a task set, such as task set 144, using temporal operators. such as choice. independent concurrency, concurrency with information exchange, disabling, enabling, enabling with information exchange, suspend/resume and order independency. As a result, the execution of the tasks in the task hierarchy can be performed efficiently, yet controlled by the framework 100.

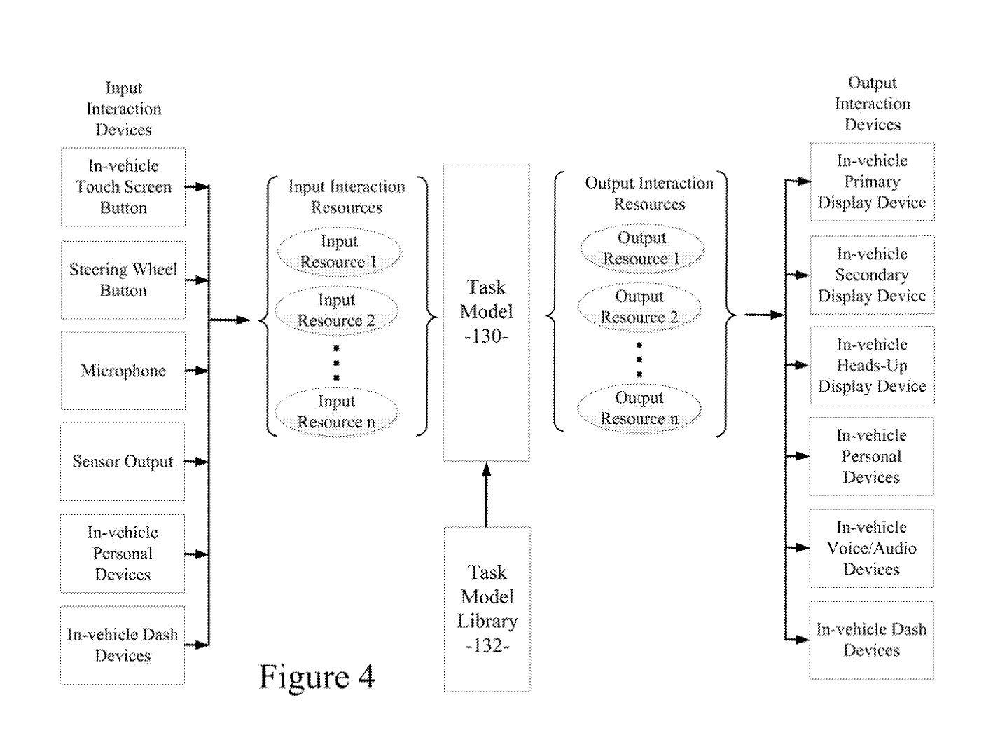

Referring again to FIG. 1, the framework 100 includes a library of task models 132, wherein each task model describes or identifies the tasks 140 a user may need to perform in different contexts 120 of use. Each task model also creates placeholders for other tasks that may be required based on an incoming notification (from other apps or services). To do this, all notifications are accompanied by as task description. The task model 130 expresses each task 140 using an abstract interaction object that is independent of any interaction device to capture the interaction modalities of the task. At run-time, the task 140 and its associated abstract interaction object can be realized through concrete interaction objects using available interaction resources 150. An interaction resource is an input/output (I/O) channel that is limited to a single interaction modality with a particular interaction device 160. For example, keyboards, screens, display surfaces, and speech synthesizers, are all examples of physical interaction resources 160 that are attached to some computing device in the environment. Each interaction resource 150 is associated with one of these interaction devices 160. In the context of the vehicle environment as shown in FIG. 4, an input interaction resource 150 can include a channel from a touch screen button, a microphone, a button on the steering wheel, or any of a variety of input devices available in a vehicle environment. In the context of the vehicle as also shown in FIG. 4, output interaction resources 150 can include a channel to a display surface like a heads-up display (HUD), a speech or audio resource like a speaker, or any of a variety of output devices available in a vehicle environment. These interaction resources 150 are associated with the devices 160 in the environment and tot-tether they form an interaction cluster or interaction group. For a vehicle environment, an interaction cluster can include as HUD, the extended instrument cluster, and as Head-Unit, among other interaction devices available in the vehicle environment.

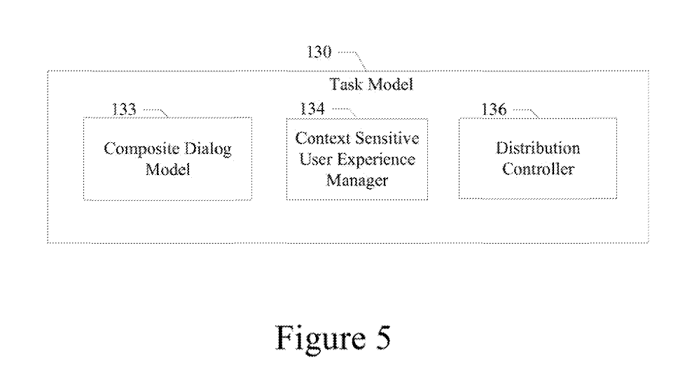

The task model 130 defines more than one equivalent way of using various interaction resources 150 on various interaction devices 160 that may be part of the interaction cluster. Further, as shown in FIG. 5, the task model 130 defines a composite dialog model 133 as a state transition network that describes the transitions that are possible between the various user interface states. The task model 130 performs task orchestration and manages the context and state transitions by dynamically building a state transition network of the interaction experience, as if the multiple integrated apps or services were a single application, although the interaction experience can be composed of many apps or services. The task model 130 provides simultaneous expression to tasks that may be fulfilled from multiple apps or services. The task model 130 can show notifications from multiple apps without switching the experience completely.

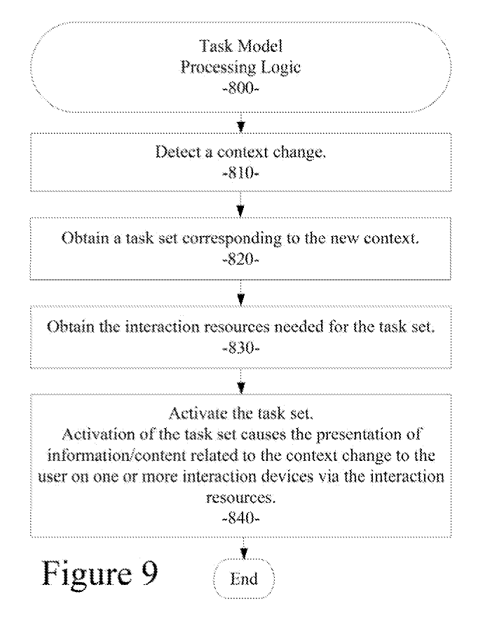

Although transitions are usually invoked by a change in context 120 or a notification request, the current context 120 is also an actor that can request a transition by virtue of a user action. The interaction resources 150 assigned by the task model 130 can use various concrete interaction resources based on the capabilities and characteristics of the interaction devices 160 that may he available in the vehicle, but the various concrete interaction resources can also be designed more generically, for any interaction cluster that might be available in a given environment. In summary, the task model 130 separates the abstraction and presentation functions of a task 140 so that the task can be realized using the available resources 160. FIG. 9 illustrates the processing 800 performed by the task model 130 in an example embodiment.

Referring again to FIGS. 1 and 5, once the task model 130 detects a context 120 change (by virtue of an asserted or requested application intent), the context sensitive user experience manager 134, shown in FIG. 5, composes the context change into the active set of tasks 140 that are temporally relevant or required to respond to the context change. The tasks 140, assigned by the task model 130 for responding to the context change, include associated abstract interaction objects and associated concrete interaction objects. There might be existing tasks that were presented to the user before the context change took place. The context sensitive user experience manager 134 determines the overall or composite dialog for the multiple simultaneous tasks that need to be presented to the user in the new context. This determination might mean replacing some existing concrete interaction objects, rearranging them, etc. The context sensitive user experience manager 134 consults a distribution controller 136 to get a recommendation on how best to re-distribute and present the concrete interaction objects using the available interaction resources 150 across the interactive cluster, such that the distribution controller 136 provides a smooth transition and a consistent experience, minimizing workload and factoring in personal relevance information, criticality or priorities, and the time sensitivity of the tasks. The distribution controller 136 makes sure that the cognitive burden of making a transition is minimized while supporting the contextual tasks and goals of the user, and the overall experience remains complete and continuous.

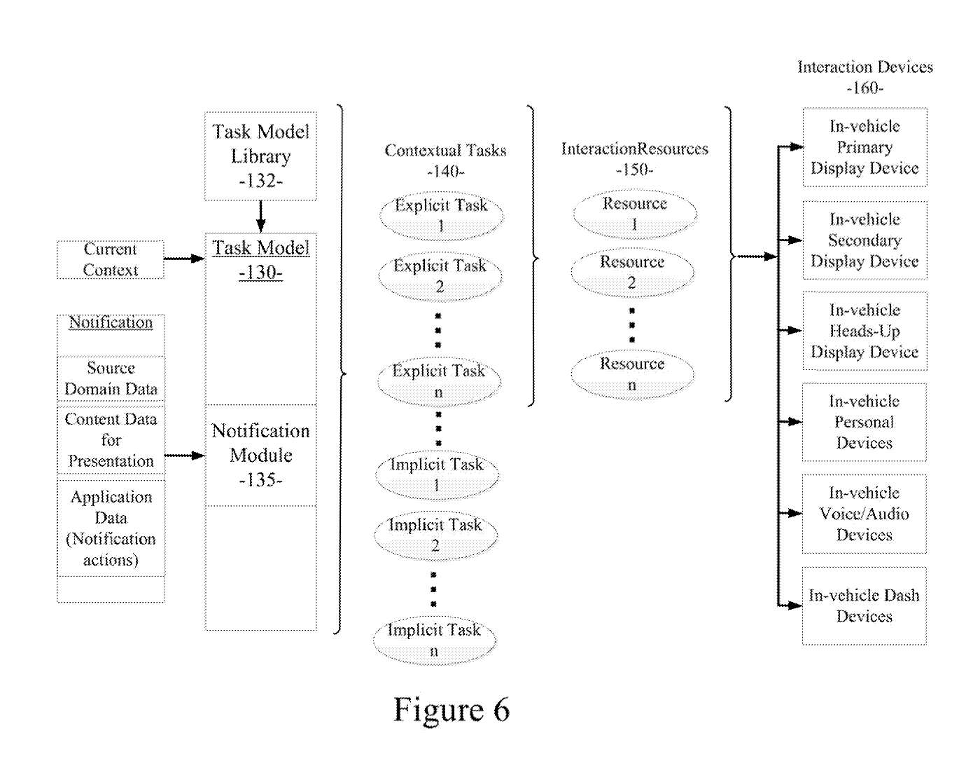

The framework 100 of an example embodiment is inclusive and can intemperate with ontologically diverse applications and services. In support of this capability as shown in FIG. 6, a notification module 135 is provided to enable any application, service, data provider, or user to present contextually relevant information in a notification. The notification module 135 of the framework 100 expects that an application intent contains: 1) domain data of the application publishing, requesting or asserting an intent (e.g., media, navigation, etc.); 2) the content data to be presented; and 3) the associated application data (e.g., actions that are available and the methods or application programming interfaces—APIs to be used to fulfill those capabilities). As an example, for an application intent such as a notification from a navigation service: a) domain data will include the spatial and temporal concepts, namely, position, location, movement and time, (b) content data will include the navigation specific content, and (c) application data will consist of the user actions and associated APIs/callbacks provided.

In summary, the framework 100 of an example embodiment considers an application intent such as an event, a published capability, or a notification as an abstract signal, a message that has a well-defined structure that includes information specifying the intent's domain, content and associated actions. The task model 130 transforms the intent abstraction into a task set that needs to be performed, in a given context, within a given set of constraints, such as a constraint corresponding to the available interaction devices 160 and their interaction and presentation resources 150. Each context sensitive task 140 can he presented using an abstract interaction object (independent of the interaction device 160) that captures the task's interaction modalities. The abstract interaction object is associated with concrete interaction objects using various input and output interaction resources 150 with various interaction devices 160 that may he associated with an available interaction cluster. Thus, like other context changes, notifications are also decomposed into tasks 140 that are enabled to respond to the notification. Thus, the task model 130 operations of mapping and planning the tasks and realizing the tasks using interaction resources is the same for notifications as with any other context change.

In the context of applications and services for a connected vehicle environment, the user experience refers to the users' affective experience of (and involvement in) the human-machine interactions that are presented through in vehicle presentation surfaces, such as a heads-up display (HUD), extended instrument cluster, audio subsystem, and the like, and controlled through in-vehicle input resources, such as voice, gestures, buttons, touch or wheel joystick, and the like.

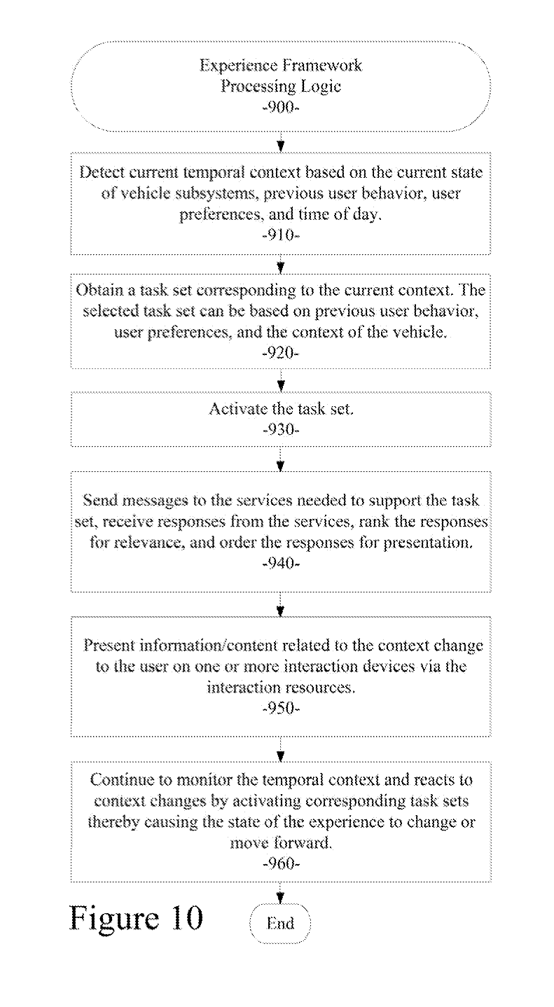

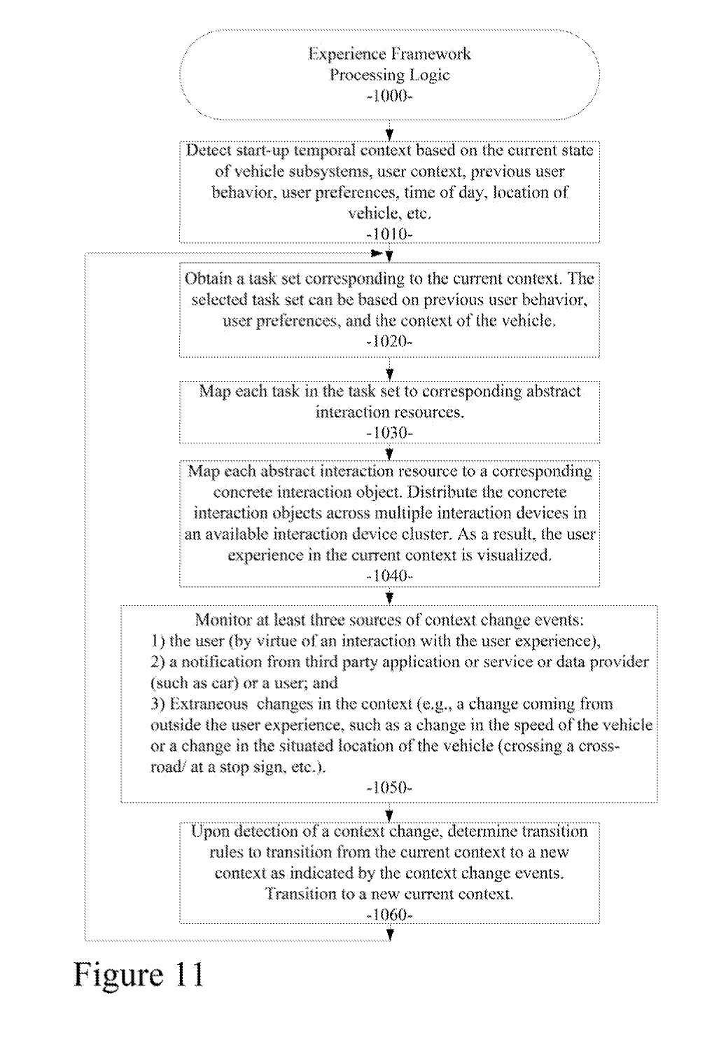

FIGS. 10 and 11 illustrate the processing performed by the experience framework 100 in an example embodiment. As shown in FIGS. 10 and 11, when the experience framework 100 of an example embodiment is instantiated, the framework 100 launches an experience based on the last known context of the vehicle. As part of launching the experience, the framework 100 performs a series of operations, including: 1) detecting the current temporal context 120; 2) assigning the applicable task set from the contextual tasks 140, the task assignment being based on the current context 120, the previous usage behavior, user preferences, etc.; 3) activating, the task set; 4) sending messages to the services the framework 100 needs to perform the tasks; 5) receiving the results; 6) ranking the results for relevance and ordering the results for presentation; and 7) dispatching the interaction resources 150 to present the state of the current context to the user by use of a concrete expression (e.g., concrete interaction objects) corresponding to the interaction resources 150. Once the initial start state of the environment context is rendered, the framework 100 continuously senses the temporal context 120, interprets the context change as described above, determines if something new needs to be presented in response to the context change, determines when, how, and where the information or content needs to be presented, and then transfers the presentation into the user experience using a concrete user interface expression thereby causing the state of the experience to change or move forward.

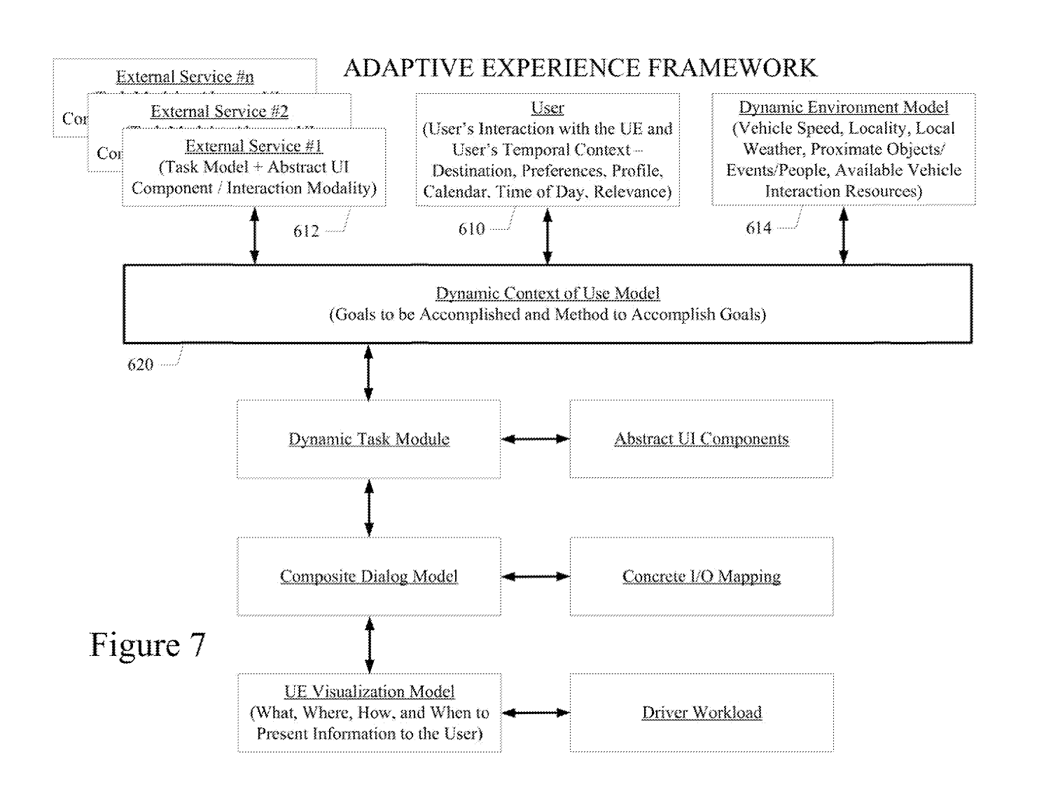

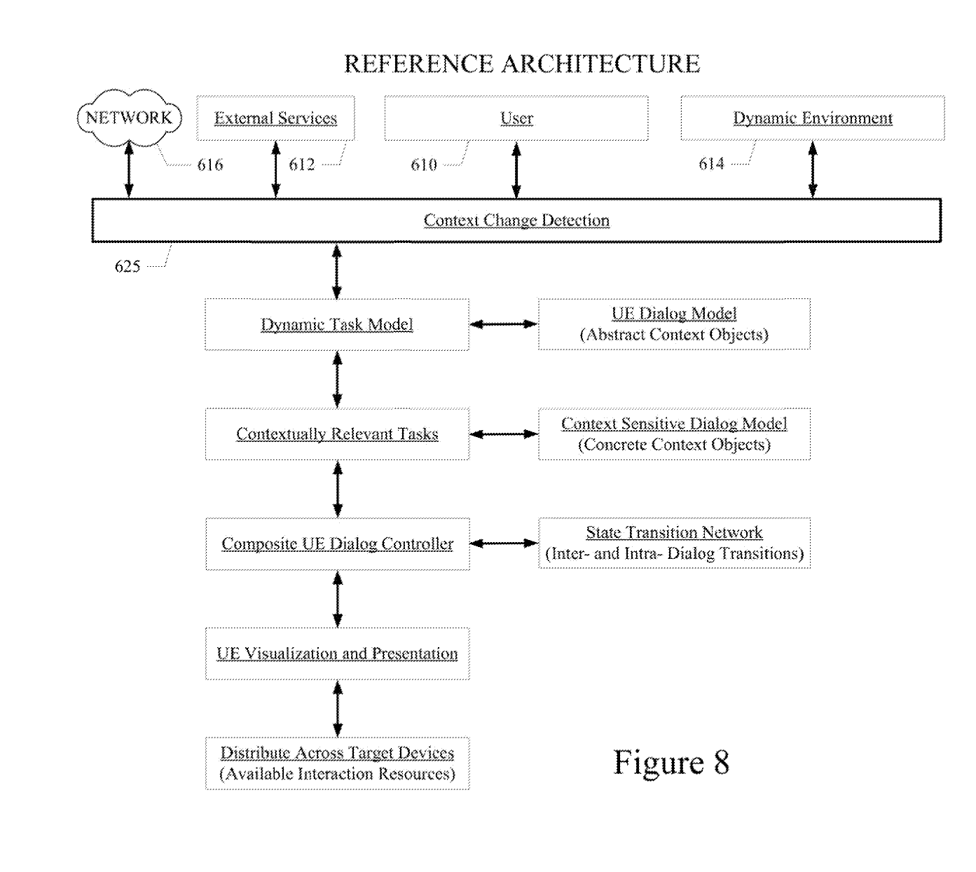

Subsequent to the rendering of the initial start state of the environment context by framework 100, user interactions can take place and the state of the experience can he changed by at least three actors: the user; the set of background applications or other external services, data sources and cloud services; and other changes in the temporal context of the dynamic environment. These actors influencing the state of the experience are shown in FIGS. 7 and 8 and described below.

The first actor, the user 610 shown in FIGS. 7 and 8, can interact with the concrete user interface expressions to control or request the actions/methods/services/metadata associated with the expressed elements. The available actions are semantically tied to each expressed element and the user experience is aware of them and provides user handles/mechanisms to control or select them. The framework 100 handles any selection or control assertion by the user, updates the presentation, and sends appropriate request and state change messages to the applicable services as described above.

The second actor, as shown in FIGS. 7 and 8, is any background application, or other external service, data service, or cloud service that wants to present some information to the user, either because the user requested the information through the presentation interaction or because the external service is publishing an event or a message to which the user or the framework 100 has subscribed. In an example embodiment, this is implemented using the intents framework, as described herein, which enables a participating application or service to advertise intents and enables users (or user data processing systems) to subscribe to these advertised intents. At run-time, the application or the service publishes these intents and they get muted for expression in the integrated experience framework, thereby making the contextually relevant vertical slice of the application or service available to the user system in a manner that preserves the application's or service's utility, usability and desirability in that environment. This is done by expressing the task(s) or task sets associated with the intent using the task model described above, visualizing the task sets using the available interaction resources, and orchestrating the execution of the task sets through their transitions. Thus, an incoming intent from an application or a service extends the scope and operability of the framework 100 as the external service can cause the invocation of a new task set containing abstract user experience components through the task model 130. Again, the framework 100 notifies any applicable services with an update to modify the dialog model.

The third actor, as shown in FIGS. 7 and 8, which is able to change the state of the user experience, includes any other changes in the temporal context of the dynamic environment. For example, any changes in the vehicle speed, locality, local weather, proximate objects/events/people, available vehicle interaction resources, or the like can trigger a corresponding activation of a task set and a corresponding presentation of information or content to the user via the interaction resources and interaction devices as described above.

As described herein, the experience framework 100 of an example embodiment is a system and method that, in real-time, makes sense of this multi-sourced data, temporal context and signals from is user's diverse set of applications, services and devices, to determine what to present, where to present it and how to present it such that the presentation provides a seamless, contextually relevant experience that optimizes driver workload and minimizes driver distraction.

Further, the experience framework 100 of an example embodiment is not modal or limited to as particular application or service that wants to manifest itself in the vehicle. Instead, the experience framework 100 is multi-modal and inclusive of any applications and services explicitly selected by the user or configured to be active and available while in-vehicle. In an example embodiment, this is done by enabling the applications and services to advertise and publish application intents in a specified format and the user (or user data processing system) to subscribe to some or all of the advertised intents. At run-time, the application or service publishes all the advertised intents; hut, only the user subscribed intents are routed to the framework. It is a framework that enables mediated interaction and orchestration between multiple applications, data, and events to present an integrated, seamlessly connected, and contextually relevant experience with coordinated transitions and interactions in an ambient intelligent environment. The experience framework 100 of an example embodiment performs task orchestration and manages the context and state transitions, as if the multiple integrated apps or services were a single application. The experience framework 100 can show notifications front multiple apps without switching the experience completely. As a result, experience framework 100 addresses distracted driving, because the framework 100 mediates all context changes and presents corresponding user interface content changes in a manner that does not result in abrupt visual and interaction context switching, which can distract a driver.

The experience framework 100 of an example embodiment enables applications and services to be brought into the vehicle without the developer or the applications or the service provider needing to be aware of the temporal context of the vehicle (e.g., the vehicle speed, location, traffic, weather, etc.) or the state of the integrated experience. The experience framework 100 assures that these applications and services brought into the vehicle get processed and expressed in a manner that is relevant and vehicle appropriate.

In a moving vehicle, consuming applications and services on the mobile device and/or the in-vehicle IVI platform results in distracted driving because it increases the manual, visual, and cognitive workload of the driver. Apart from consuming an application or service like, navigation or music, drivers want to stay connected with people, places, and things in their digital world. Users consume notifications from these mobile applications and cloud services, and these notifications further increase driver workload as drivers switch contexts on receipt of the notifications. The problem gets compounded as changes in the temporal context caused by the dynamic environment (e.g., changes in vehicle speed, location, local traffic, and/or weather conditions, etc.) also increase the driver workload, narrowing the safety window.

Today, there are two broad approaches to addressing distracted driving. One approach is to limit the use of an application or service by de featuring or locking the application or service when the vehicle is in motion. Another approach is designing applications that specifically address distracted driving. The first approach does not seem to work in the general public. For example, when an in-vehicle app gets de-featured on an in-vehicle IVI, drivers tend to use their mobile device, which does not lock or de-feature the app when the vehicle is moving. The second approach is dependent on the application developer and the use eases the app developer covers to address distracted driving. However, even if a particular application is well designed from a distracted driving point of view, the app cannot always be aware of the context of the vehicle. Further, applications tend to be different in terms of the information or content they want to present, their interaction model, their semantics, and the fact that different people are developing them; their experience will very likely he different and difficult to reconcile with resources available in the environment. Furthermore, as the user uses the apps, switches from one application to another, or consumes a notification from an app or service, the context changes increase the driver's visual, manual and cognitive workload. As a result, there is no good solution to addressing distracted driving in conventional systems.

The experience framework 100 described herein addresses the problem of distracted driving by taking a more holistic view of the problem. The experience framework 100 operates at a broad level that enables the unification of in-vehicle systems, mobile devices, and cloud-based resources. The experience framework 100 enables applications and services to advertise and publish intents that can be consumed by the user (or the user data processing system) in their vehicle in a manner that is vehicle-appropriate. As a result, experience framework 100 can monitor and control a unified in-vehicle experience as a whole as opposed to dealing with individual systems on a per application basis. The experience framework 100 as described herein interoperates with multiple data sources, applications and services, performing processing operations to determine what, when, where and how to present information and content, such that the framework 100 can address distracted driving at the overall in-vehicle experience level. This means that apps and/or services do not necessarily run directly in the vehicle or on a user's mobile device. Rather, the apps and/or services get incarnated and presented through a uniform, consistent user experience that homogenizes the apps and/or services as if one vehicle-centric application was providing all services. The framework 100 minimizes the dynamic driver workload based on a vehicle's situational awareness, scores the relevance of what is requested to be presented based on the user's and vehicle's temporal context, and leverages a few vehicle-safe patterns to map and present the diversity of application, data, and content requests. Because the framework 100 can dynamically and seamlessly integrate the user interfaces of multiple devices, services, and/or apps into the environment and into the user experience, the framework 100 eliminates the additional visual and cognitive workload of the driver that occurs if the driver must adapt to the significant differences in user interaction controls, placement, interaction modalities, and memory patterns of widely variant user interfaces from different non-integrated devices, services, and/or apps. Additionally, the framework 100 is inclusive and can be applied across ontologically diverse applications and services.

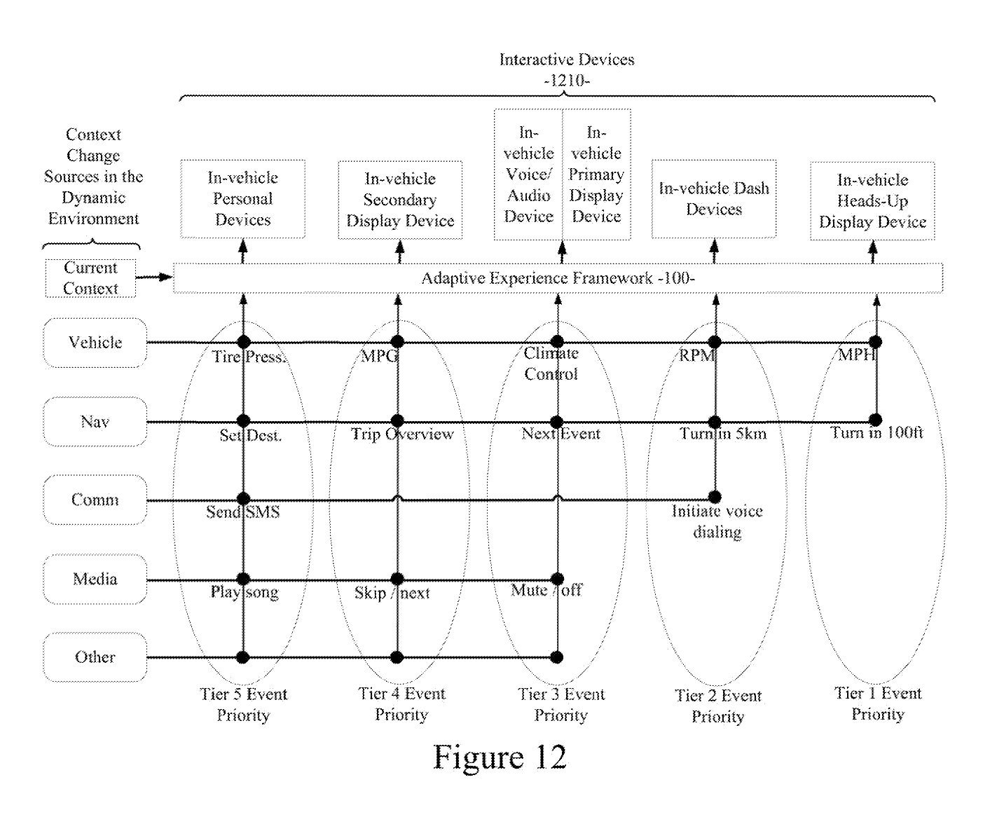

Referring now to FIG. 12, an example of the framework 100 in a vehicle environment is illustrated. As shown, the vehicle environment can source a variety of context change events, application intents, or notifications (e.g., events from a variety of vehicle subsystems, such as vehicle sensors, a navigation subsystem, a communication subsystem, a media subsystem, and the like. Each context change event, notification, or application intent can have a particular priority or level of criticality in the dynamic environment. As a result of these context changes, the framework 100 can assign a corresponding task set, as described above, to cause information or content presentations on one or more of the interactive devices 1210 in the vehicle environment. Because the framework 100 is holistically aware of the vehicle environment, the framework 100 can present the information or content to the user in as context-sensitive and priority-sensitive manner that is most likely to convey necessary information to the driver in the least distracting manner possible. For example, a message to the driver from the navigation subsystem regarding a high priority imminent torn can be shifted to the HUD, even though the message might he usually displayed on the primary display device on the dashboard. Similarly, while the high priority navigation message is being presented, less important messages in the particular context, such as those from the media or communication subsystems, can be suppressed or delayed until the higher priority presentations are completed. This is just one representative example of the dynamic nature of the adaptive experience framework 100 as described herein.

The holistic nature of the framework 100 makes the framework applicable beyond delivering only vehicle-centric or vehicle-safe experiences. The framework 100 can also he used to provide contextually relevant and consistent experiences for connected devices, in general. This is because applications on connected devices, such as mobile devices or tablet devices, are consumed exclusively where the active application has an absolute or near-complete control of the device's presentation and interaction resources. Other applications can continue to run in the background (e.g., playing music); but, anytime the user wants to interact with them, that background application must switch to the foreground and in turn, take control of the presentation and interaction resources. This process results in a fragmented or siloed user experience, because the user's context completely switches from the previous state to the new state. As long as the user remains within the active application's context, other applications and services remain opaque, distant, and. generally inaccessible to the user. While background applications and services can send event notifications (such as a SIMS notification or a Facebook message) that get overlaid on top of the active application, the user cannot consume and interact with the event notification until the active application performs a context switch to change from the current application to the notifying application.

The experience framework 100 as described herein provides a context fabric that stitches application intents, transitions, notifications, events, and state changes together to deliver consistent experiences that are homogeneous, composed using a set of contextual tasks and interaction resources that address distracted driving and driver workload, in the context of the vehicle environment as described herein, the experience framework 100 manifests itself as the foreground or active application, and all other applications, cloud services, or data sources run in the background as if they were services. In other words, the experience framework 100 treats all applications, cloud services, and data providers as services and interacts with them through service interfaces, exchanging application intents and the associated data and messages via APIs. The experience framework 100 essentially implements a dynamic model that represents context changes and provides an intent-task model to react to these context changes in an appropriate way, which in a vehicle environment means addressing driver distraction as well.

Thus, a system and method for providing an adaptive experience framework for an ambient intelligent environment are disclosed,

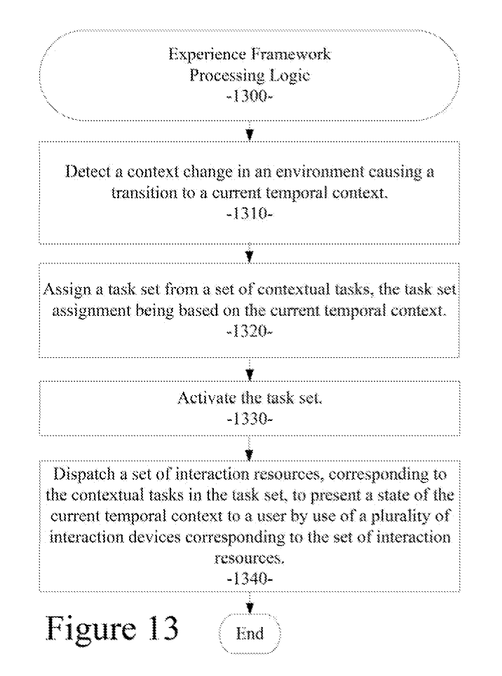

FIG. 13 is a processing flow diagram illustrating an example embodiment of a system and method for providing an adaptive experience framework for an ambient intelligent environment as described herein. The method 1300 of an example embodiment includes: detecting a context change in an environment causing a transition to a current temporal context (processing block 1310); assigning, by use of a data processor, a task set from a set of contextual tasks, the task set assignment being based on the current temporal context (processing block 1320); activating the task set (processing block 1330); and dispatching a set of interaction resources, corresponding to the contextual tasks in the task set, to present a state of the current temporal context to a user by use of a plurality of interaction devices corresponding to the set of interaction resources (processing block 1340).

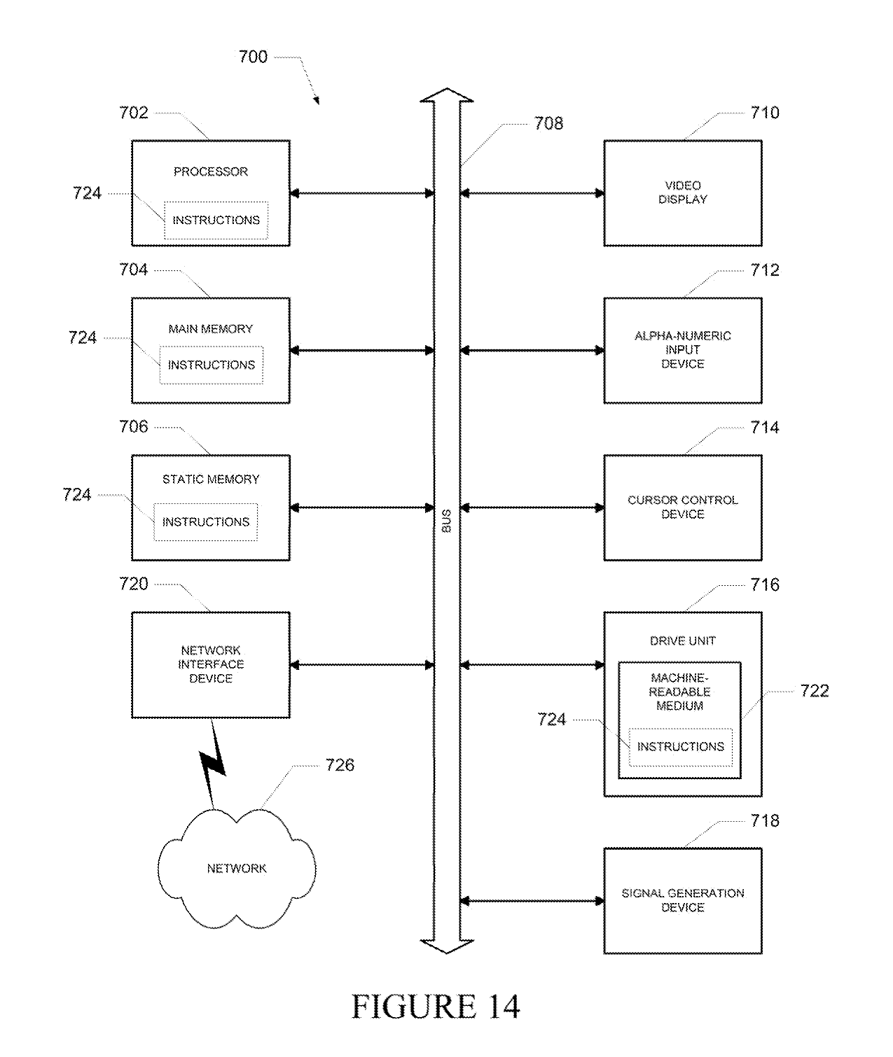

FIG. 14 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (FDA), a cellular telephone, a web appliance, a network router, switch or bridge, or any machine capable of executing a set of instructions (sequential or otherwise) that specify actions to be taken by that machine, Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §172(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
detecting a context change in an environment causing a transition to a current temporal context;
assigning, by use of a data processor, a task set tram a set of contextual tasks, the task set assignment being based on the current temporal context;
activating the task set; and
dispatching a set of interaction resources, corresponding to the contextual tasks in the task set, to present a state of the current temporal context to a user by use of a plurality of interaction devices corresponding to the set of interaction resources.

2. The method as claimed in claim 1 including:
sending messages to any services needed to perform the contextual tasks;
receiving results from the services; and
ranking and ordering the results for presentation.

3. The method as claimed in claim 1 wherein detecting the context change includes receiving an indication of user interaction with a user interface.

4. The method as claimed in claim 1 wherein detecting the context change includes receiving a notification from an application, service, or data provider.

5. The method as claimed in claim 1 wherein detecting the context change includes receiving an indication from an external source.

6. The method as claimed in claim 1 wherein the task set has a task hierarchy.

7. The method as claimed in claim 1 wherein the environment is a vehicle environment.

8. The method as claimed in claim 1 wherein the context change has an associated priority.

9. The method as claimed in claim 8 wherein the task set is assigned based in part on the associated priority of the context change.

10. A system comprising:
one or more data processors; and
a adaptive experience framework, executable by the one or more data processors, to:
detect a context change in an environment causing a transition to a current temporal context;
assign a task set from a set of contextual tasks, the task set assignment being based on the current temporal context;
activate the task set; and
dispatch a set of interaction resources, corresponding to the contextual tasks in the task set, to present a state of the current temporal context to a user by use of a plurality of interaction devices corresponding to the set of interaction resources.

11. The system as claimed in claim 10 being further configured to:
send messages to any services needed to perform the contextual tasks;
receive results from the services; and
rank and ordering the results for presentation.

12. The system as claimed in claim 10 being further configured to detect the context change by receiving an indication of user interaction with a user interface.

13. The system as claimed in claim 10 being further configured to detect the context change by receiving a notification from an application, service, or data provider.

14. The system as claimed in claim 10 being further configured to detect the context change by receiving an indication from an external source.

15. The system as claimed in claim 10 wherein the task set has a task hierarchy.

16. The system as claimed in claim 10 wherein the environment is a vehicle environment.

17. The system as claimed in claim 10 wherein the context change has an associated priority.

18. The system as claimed in claim 17 being further configured to assign the task set based in part on the associated priority of the context change.

19. A non-transitory machine-useable storage medium embodying instructions which, when executed by a machine, cause the machine to:
detect a context change in an environment causing as transition to a current temporal context;
assign a task set from a set of contextual tasks, the task set assignment being based on the current temporal context;
activate the task set; and
dispatch a set of interaction resources, corresponding to the contextual tasks in the task set, to present a state of the current temporal context to a user by use of a plurality of interaction devices corresponding to the set of interaction resources.

20. The machine-useable Storage medium as claimed in claim 19 wherein the environment is a vehicle environment.
